(19) United States
(12) Patent Application Publication
(10) Pub. No.: US 2009/0160144 A1
(43) Pub. Date: Jun. 25, 2009

(54) SLED FORMED FROM FLAT SHEET OF FLEXIBLE MATERIAL

(76) Inventor: Jonathan Kleinsasser, Ste. Agathe (CA)

Correspondence Address: ADE & COMPANY INC., 2157 Henderson Highway, WINNIPEG, MB, R2G1P9, CA

(21) Appl. No.: 11/959,612

(22) Filed: Dec. 19, 2007

(51) Int. Cl. B62B 15/00

(52) U.S. Cl. 280/19

(57) ABSTRACT

A sled formed of a sheet of a flat flexible plastics material includes two holes at the sides rearward of the front edge and at the front edge two further holes such that, when a rope extends between the holes, the rope holds the front edge pulled rearwardly and upwardly to form a curved front of the sled. The holes at the front edge each are arranged with a wider portion, which is dimensioned so that a knot on the rope can pass through the wider portion, and a narrower portion, which is dimensioned to receive the rope but prevents passage of the knot, and a neck between the wider and narrower portions though which the rope can be forced to hold the rope in the narrower portion. The wider portion forms a hand hole.

This invention relates to a sled formed from a flat sheet of a flexible material.

### BACKGROUND OF THE INVENTION

In U.S. Pat. No. 3,484,801 (Carlin) issued Mar. 8, 1968 is a basic sled formed from a flat sheet of a flexible plastics material which is simply cut to define a width and length sufficient that the rider can sit on the sheet. The sheet is cut to define a curved front edge with a handle hole at the center which can be pulled upwardly and inwardly by the rider toward the rider so curve the bottom surface across the front of the sled. This very simple form of sled has been very successful because of the low cost and simple transportation. The sheet can be laid flat or rolled for transportation and storage.

Little has changed in such sleds and many slightly different designs have been manufactured and sold over the years.

It is common to use a rope in association with the sled which can be attached simply by passing the rope though a hole in the material and forming a knot on the rope on one side of the sheet. The rope can be used to pull the sled or can be used to hold the sled in a required shape including particularly the front curved shape. An example of this arrangement is shown in U.S. Pat. No. 4,283,068 (Keyser) issued Aug. 11, 1981.

### SUMMARY OF THE INVENTION

It is one object of the invention to provide an improved sled of this type which allows the sled to be supplied in flat form and quickly and easily formed into the front curved arrangement.

According to one aspect of the invention there is provided a sled comprising:

a sheet of a flat flexible material shaped and arranged to receive a rider on the sheet, the material being arranged to provide a bottom surface arranged to slide on the snow;

the sheet having first and second side edges and a front edge;

at a first position adjacent the first side edge and rearward of the front edge there being provided at least one first hole for receiving a rope;

at a second position adjacent the second side edge and rearward of the front edge there being provided at least one second hole for receiving a rope;

at a third position adjacent the front edge and adjacent the first side edge there being provided at least one third hole for receiving a rope;

at a fourth position adjacent the front edge and adjacent the second side edge there being provided at least one fourth hole for receiving a rope;

the first and third holes being arranged such that, when a rope extends between the first and third holes, the rope holds the front edge pulled rearwardly and upwardly to form a curved front of the sled;

the second and fourth holes being arranged such that, when a rope extends between the second and fourth holes, the rope holds the front edge pulled rearwardly and upwardly to form a curved front of the sled;

the third and fourth holes each being arranged with a wider portion, which is dimensioned so that a knot on the rope can pass through the wider portion, and a narrower portion, which is dimensioned to receive the rope but prevents passage of the knot, and a neck between the wider and narrower portions though which the rope can be forced to hold the rope in the narrower portion.

Preferably the wider portion is shaped to form a hand hold.

Preferably the wider portion is generally rectangular with a wider edge parallel to the front edge.

Preferably the wider portion is generally rectangular with the narrower portion at one corner.

Preferably the narrower portion is at an outside corner.

Preferably at the first location there are provided two first holes with one in front of the other and at the second location there are provided two second holes with one in front of the other.

Preferably at the first location there are provided two first holes so that the rope can pass downwardly through one and upwardly through the other with a portion of the rope on the underside and at the second location there are provided two second holes so that the rope can pass downwardly through one and upwardly through the other with a portion of the rope on the underside.

Preferably at a fifth location adjacent a center line and between the front edge and a line joining the first and second locations there is provided at least one fifth hole through which the rope can extend for providing a front pulling portion of the rope.

Preferably along at least a part of the length of the sheet there is provided at least one longitudinal punch line.

Preferably along each side edge rearwardly of the first and second positions is provided at least one hand hole.

### BRIEF DESCRIPTION OF THE DRAWINGS

One embodiment of the invention will now be described in conjunction with the accompanying drawings in which:

FIG. 1 is a top plan view of the sheet forming the sled according to the present invention.

FIG. 2 is a top plan view on an enlarged scale showing the shape of the hole at the front edge.

FIG. 3 is an isometric view of the assembled sled of FIG. 1.

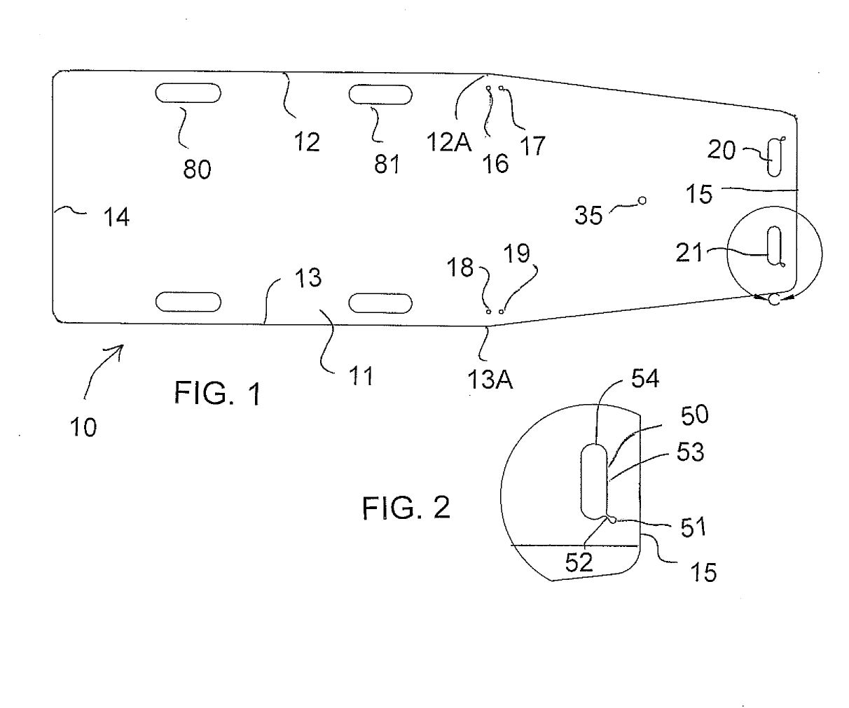

In the drawings like characters of reference indicate corresponding parts in the different figures.

### DETAILED DESCRIPTION

The sled 10 is formed from a sheet 11 of a flat flexible material shaped and arranged to receive a rider on the sheet. The sheet is formed of a plastics material which is stiff enough to support the rider sliding over the snow or ice with the material being arranged to provide a smooth bottom surface arranged to slide on the snow.

The sheet has first and second side edges 12 and 13, a rear edge 14 and a front edge 15. The side edges converge inwardly and forwardly from a point 12A and 13A toward the narrower front edge 15.

At the first location 12A adjacent the first side edge 12 and rearward of the front edge 15 there is provided two holes 16 and 17 for receiving a rope. The holes are aligned parallel to the side edge with one in front of the other.

At the second location 13A adjacent the first side edge 13 and rearward of the front edge 15 there is provided two holes 18 and 19 for receiving a rope. The holes are aligned parallel to the side edge with one in front of the other.

At a third location closely adjacent the front edge 15 and adjacent the first side edge 12 there is provided a third hole 20 for receiving a rope and at a fourth position adjacent the front edge 15 and adjacent the second side edge 13 there is provided a fourth hole 21 for receiving a rope. Thus the holes 20 and 21 are side by side at the front edge 15.

The first and third holes being arranged such that, when a rope extends between the first and third holes, the rope holds the front edge pulled rearwardly and upwardly to form a curved front of the sled;

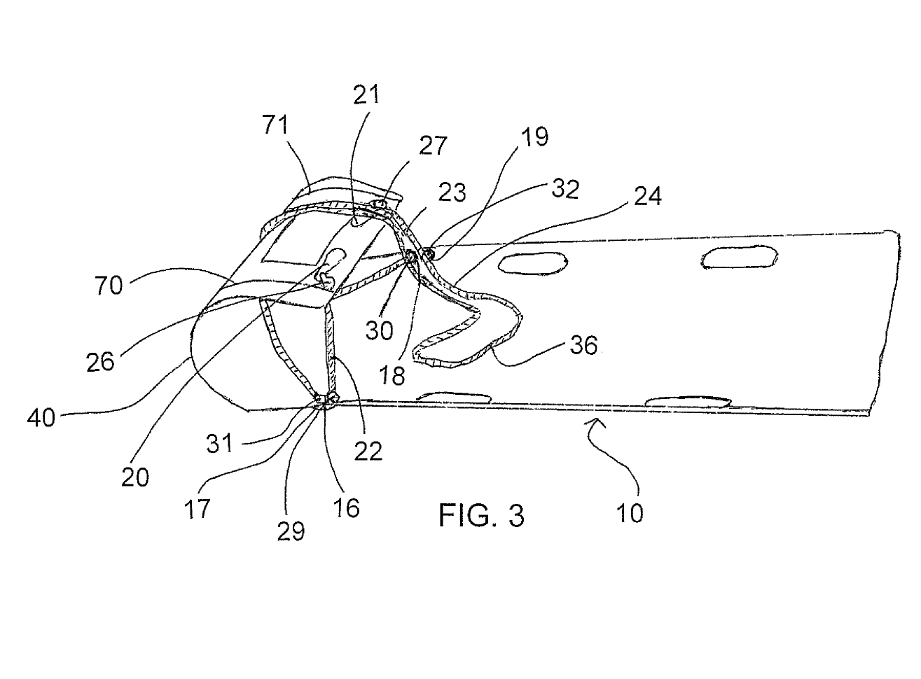

As shown in FIG. 3, a rope 24 has a knot 26, 27 on each end. The knots are arranged at the holes 20 and 21 respectively. The rope extends from the holes 20, 21 to the holes 16, 18 respectively where there is located a second knot 29, 30 which locates the position of the rope at the sheet. The rope passes through the holes 16 and 18 and back through the holes 17 and 19 so that a short portion of the rope is on the underside of the sheet on each side adjacent the side edge.

At the holes 17, 19 further knots 31, 32 are provided in the rope which locates the rope at the top surface of the sheet. From the knots 31 and 32, the rope extends inwardly and forwardly to a central hole 35 where the two strands of the rope pass through the hole 35 to form a loop 36 which can be pulled to pull the sled forwardly.

The holes 16 and 20 are arranged such that, when a portion 22 of the rope 24 extends between the holes, the rope portion 22 holds the front edge pulled rearwardly and upwardly to form a curved front 40 of the sled.

The holes 18 and 20 are symmetrically arranged relative to the holes 16 and 20 such that, when a portion 23 of the rope 24 extends between the holes, the rope portion 23 holds the front edge pulled rearwardly and upwardly to form the curved front 40 of the sled.

Each of the holes 17 and 20 as best shown in FIG. 2 has a wider portion 50, which is dimensioned so that the knot 26, 27 on the rope can pass through the wider portion, and a narrower portion 51, which is dimensioned to receive the rope but prevents passage of the knot 26, 27, and a neck 52 between the wider and narrower portions though which the rope can be forced to hold the rope in the narrower portion 51. Thus the knots 26, 27 can be released from the holes 20 and 21 by forcing the rope through the narrower neck into the wider portion where the knot simply falls through the wider hole portion. When released, with the rope remaining attached to the remainder of the sled and passing though the remaining holes, the front part of the sled falls back to its flat condition. When it is required to assemble the sled to its curved portion for use, the front edge is grabbed and pulled upwardly and the rope re-engaged with the holes 20 and 21 by insertion of the knot back into the narrower portion 51 past the neck 52.

The wider portion 50 is shaped to form a hand hold and is generally rectangular with a wider edge 53 parallel to the front edge 15 and two curved ends 54. The narrower portion 51 is located at the outer corner of the rectangular shape so as to locate the rope closest to the corner between the front edge and side edges.

The hole 35 is located at or adjacent a center line and between the front edge and a line joining the first and second locations 12A and 13A through which the rope can extend for providing a front pulling portion of the rope. This location places the rope when pulled at the center and at the forward most point of the curved part 40. The hole 35 is larger than the other holes so that both strands of the rope can pass through and can be threaded through from one side.

Along at least a part of the length of the sheet there is provided at least one longitudinal punch line 70, 71 where the sheet is slightly distorted downwardly to simulate a runner and provide some guidance of the sled over the ice.

Along each side edge rearwardly of the first and second positions 12A, 13A is provided a pair of longitudinally spaced hand holes 80 and 81.

The sled with the rope fully attached can thus be stored in flat condition for transportation and storage of a large number of the sleds stacked. But from this flat condition the sled can be quickly assembled to the curved portion for use simply by inserting the rope ends into the holes 20 and 21. The flat storage condition is useful both in the stacked condition for sale and in use of the sled after purchase. The assembly of the rope to its required lengths with the knots properly located avoids the purchaser from having to trouble with forming the knots and selecting and measuring the distances since the rope can be already assembled and in proper location when the sled is purchased.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A sled comprising:
a sheet of a flat flexible material shaped and arranged to receive a rider on the sheet, the material being arranged to provide a bottom surface arranged to slide on the snow:
the sheet having first and second side edges and a front edge;
at a first position adjacent the first side edge and rearward of the front edge there being provided at least one first hole for receiving a rope;
at a second position adjacent the second side edge and rearward of the front edge there being provided at least one second hole for receiving a rope;
at a third position adjacent the front edge and adjacent the first side edge there being provided at least one third hole for receiving a rope;
at a fourth position adjacent the front edge and adjacent the second side edge there being provided at least one fourth hole for receiving a rope;
the first and third holes being arranged such that, when a rope extends between the first and third holes, the rope holds the front edge pulled rearwardly and upwardly to form a curved front of the sled;
the second and fourth holes being arranged such that, when a rope extends between the second and fourth holes, the rope holds the front edge pulled rearwardly and upwardly to form a curved front of the sled;
the third and fourth holes each being arranged with a wider portion, which is dimensioned so that a knot on the rope can pass through the wider portion, and a narrower portion, which is dimensioned to receive the rope but prevents passage of the knot, and a neck between the wider and narrower portions though which the rope can be forced to hold the rope in the narrower portion.

2. The sled according to claim 1 wherein the wider portion is shaped to form a hand hold.

3. The sled according to claim 1 wherein the wider portion is generally rectangular with a wider edge parallel to the front edge.

4. The sled according to claim 1 wherein the wider portion is generally rectangular with the narrower portion at one corner.

5. The sled according to claim 4 wherein the narrower portion is at an outside corner.

6. The sled according to claim 1 wherein at the first location there are provided two first holes with one in front of the other and at the second location there are provided two second holes with one in front of the other.

7. The sled according to claim 1 wherein at the first location there are provided two first holes so that the rope can pass downwardly through one and upwardly through the other with a portion of the rope on the underside and at the second location there are provided two second holes so that the rope can pass downwardly through one and upwardly through the other with a portion of the rope on the underside.

8. The sled according to claim 1 wherein at a fifth location adjacent a center line and between the front edge and a line joining the first and second locations there is provided at least one fifth hole through which the rope can extend for providing a front pulling portion of the rope.

9. The sled according to claim 1 wherein along at least a part of the length of the sheet there is provided at least one longitudinal punch line.

10. The sled according to claim 1 wherein along each side edge rearwardly of the first and second positions is provided at least one hand hole.
